(19) United States
(12) Patent Application Publication
(10) Pub. No.: US 2022/0276388 A1
(43) Pub. Date: Sep. 1, 2022

(54) Method for Determining a Model for Describing at least one Environment-Specific GNSS Profile

(71) Applicant: Robert Bosch GmbH, Stuttgart (DE)

(72) Inventors: Christian Skupin, Garbsen (DE); Hanno Homann, Hannover (DE); Moritz Michael Knorr, Hildesheim (DE)

(21) Appl. No.: 17/628,335

(22) PCT Filed: Jul. 15, 2020
(86) PCT No.: PCT/EP2020/069932

§ 371 Date: Jan. 19, 2022

(30) Foreign Application Priority Data
Jul. 26, 2019 (DE) 10 2019 211 174.2

(51) Int. Cl. G01S 19/07; G01S 19/14

(52) U.S. Cl. CPC G01S 19/07; G01S 19/14

(57) ABSTRACT

The disclosure relates to a method for determining a model for describing at least one environment-specific GNSS profile, comprising at least the following steps: a) receiving at least one measurement data record, which describes at least one GNSS parameter of a GNSS signal between a GNSS satellite and a GNSS receiver, b) using the measurement data record received in step a) to determine at least one model parameter for a model for describing the at least one environment-specific GNSS profile, and c) providing the model for describing the at least one environment-specific GNSS profile.

The invention concerns a method for determining a model for describing a least one environment-specific GNSS profile, a computer program for carrying out the method and a machine-readable storage medium on which the computer program is stored. The invention can be used in particular for autonomous driving.

### PRIOR ART

Among other things, a vehicle for autonomous operation requires a sensor system that is capable of determining a highly accurate vehicle position, in particular using navigation satellite data (GPS, GLONASS, Beidou, Galileo). At present, this is accomplished by receiving GNSS (global navigation satellite system) signals by way of a GNSS antenna on the vehicle roof and processing said signals using a GNSS sensor.

To improve GNSS accuracy, GNSS correction data services are known that are able to determine the error influence of GNSS errors in orbit (essentially satellite orbit errors, satellite clock errors, code and phase biases, and also ionospheric and tropospheric refractive influences). Such existing correction data services can be used to factor in said error influences for GNSS-based location, which means that the accuracy of the GNSS-based location result increases. However, in urban environments, for example, significant shadowing of the GNSS satellites can occur, in particular in urban canyons. In addition, reflections of the GNSS signal from the houses can occur, which can lead to so-called multipath propagation and related pseudorange errors. Efforts are made to also in such influences in order to improve the accuracy of GNSS-based location further still.

The existing correction data services allow an increase in the accuracy of GNSS-based location in the cm range while there is a line of sight to the satellites that are being used. In the case of shadowing, e.g. by high buildings, although use of correction data services generally continues to achieve an increase in accuracy as compared with nonuse of correction data, location accuracy still deteriorates in this case (e.g. to an accuracy in the order of magnitude of one meter or 10 meters).

A particular problem is that, even when using correction data in the case just described, a GNSS receiver does not detect the arising error completely, which means that e.g. a larger error ellipse can certainly be assumed, but with an incorrect center for the ellipse. Such degradation of location reliability by means of GNSS-based systems should be avoided as far as possible e.g. for the accuracy and integrity demands on a GNSS-based location system for use for highly automated or autonomous driving.

### DISCLOSURE OF THE INVENTION

The proposal here, according to claim 1, is a method for determining a model for describing at least one environment-specific GNSS profile, comprising at least the following steps:
a) receiving at least one measurement dataset that describes at least one GNSS parameter of a GNSS signal between a GNSS satellite and a GNSS receiver,
b) determining at least one model parameter for a model for describing the at least one environment-specific GNSS profile, using the measurement dataset received in step a),
c) providing the model for describing the at least one environment-specific GNSS profile.

In this regard, GNSS stands for global navigation satellite system, such as for example GPS (Global Positioning System) or Galileo. The indicated order of steps a), b) and c) is illustrative and can arise as such for a normal operating cycle of the method, or can proceed at least once in the indicated order. In addition, at least steps a), b) and c) can also at least sometimes be carried out in parallel or at the same time.

This allows an entire new model approach to be provided, which is based on environment-specific GNSS profiles. The model approach particularly advantageously helps to save volumes of data and hence resources (storage space). Nevertheless, GNSS profiles can be used to advantageously improve location accuracy. This in particular also in urban environments in which shadowing of the satellites can occur.

Step a) involves receiving at least one measurement dataset that describes at least one GNSS parameter of a GNSS signal between a GNSS satellite and a GNSS receiver. A multiplicity of measurement datasets can be received that each describe a GNSS parameter such as for example a propagation path, or the reception situation, of a GNSS signal between a GNSS satellite and a GNSS receiver. For this purpose (if applicable beforehand), it is possible to record measurement data from which the measurement datasets are formed. In this regard, it is preferred if the measurement data are recorded by one or more (motor) vehicles, for example by way of GNSS receivers and/or environment sensor systems of the vehicles. The vehicles are preferably automobiles that are particularly preferably designed for automated or autonomous operations.

The measurement datasets generally each comprise the following (signal-specific) measurement data:
the (actual) position of the GNSS receiver (at which position the GNSS signal was received),
the satellite position of the GNSS satellite (that transmitted the GNSS signal),
the measured pseud range (PR) of the GNSS signal, and
the measured. signal strength of the GNSS signal (alternatively C/N0) and/or other GNSS raw measurements (e.g. Doppler and carrier phase).

The (actual) position of the GNSS receiver (for example a reception antenna) can be determined (even in the event of disturbances in the signal propagation of the GNSS signal) by means of dual-frequency receivers, for example. Dual-frequency receivers are GNSS receivers that can analyze the radio signals arriving from the GNSS satellites on both coded frequencies (L1 and L2). The measurement principle is—beyond normal pseudoranging (where only L1 is received)—phase measurement of the carrier waves. Applicable dual-frequency receivers may be installed in or on (motor) vehicles, for example. In this regard, the vehicles can be vehicles that are supposed to travel along routes intended specifically for the purpose of creating the measurement datasets, for example.

Alternatively or additionally, an environment sensor system can help to determine the (actual) position of the GNSS receiver. This can involve measurement data from the environment sensor system being combined with GNSS measurement data or used on their own. The environment sensor system may be installed in or on (motor) vehicles, for example. In this regard, the position of the GNSS receiver may coincide, by way of illustration, with a vehicle position. The environment sensor system can be an optical sensor (for example a camera), an ultrasonic sensor, a RADAR sensor, a LIDAR sensor or the like, for example.

Given the position of the GNSS receiver and the satellite position, the LOS (line of sight) distance, or the direct (shortest) connecting line, between GNSS satellite and GNSS receiver is generally also known. The pseudorange (PR) is generally measured by way of a propagation delay measurement (for example of the L1 frequency) for the GNSS signal. Given the points position of the GNSS receiver, satellite position and pseudorange, the pseudorange error (PR error) is also known (for example by way of the equation: PR error=measured PR−LOS distance).

The measurement data are advantageously first collected over a relatively long period, for example over at least ten days, and/or using crowdsourcing. In this regard, crowdsourcing can also be described by stating that the measurements of different measurement instances are collated. This can be accomplished for example by collating the measurement data of different vehicles that have stopped in an observation region (from which the 3D environment model is supposed to be created) over an observation period (for example ten days or more).

Step b) involves determining at least one model parameter for a model for describing (in a simplified manner) the at least one environment-specific GNSS profile, using the measurement dataset received in step a). In particular, step b) can involve deriving, or abstracting, a model parameter, or a model, for describing multiple GNSS profiles from multiple received measurement datasets. The model advantageously permits GNSS profiles to be described in a simplified manner, by means of model parameters, as a result of which it is possible to save volumes of data and/or computing capacity (in comparison with providing the complete GNSS profiles containing for example all of the GNSS raw data).

A (every) GNSS profile fundamentally describes a relationship between a path length determined from the satellite data (and/or a path length error determined from the satellite data (or the path length) and the receiver position ascertained in step a)) and the pair of values comprising receiver position and satellite position. These GNSS profiles, or the relationships from these GNSS profiles, are intended to be provided in an advantageously simplified manner here by way of the model approach.

The satellite position here usually relates to the position of the satellite that transmitted the applicable satellite data, or the GNSS signal, at the time of the transmission. To simplify matters, the receiver position can be equated with a vehicle position of the vehicle that has the GNSS receiver, for example. The profile is environment-specific, since the data of said profile, for example path length errors, are influenced by the environment, or are dependent thereon.

The model is in particular formed such that it permits a compact description of the functional relationship between measured variable and dependency parameter. Moreover, the model can be formed such that a multiplicity of measured values are merged into few (in particular statistical) parameters (e.g. mean value and variance).

The model can be a linear model, for example. Moreover, the model can be multidimensional, such as for example three-dimensional. In addition, the model can be environment-specific (like the GNSS profiles it describes).

The model can alternatively or additionally comprise mapping of GNSS signal characteristics in the form of (a parametric description of) GNSS profiles. This can be an additional map layer of an existing roadmap (e.g. NDS map), for example.

Step c) involves providing the model for describing the at least one environment-specific GNSS profile. By way of example, the model can be determined outside a vehicle, in particular on the basis of data that were recorded using vehicles. To this end, the model can be formed in a superordinate evaluation unit, for example. The model can subsequently be transmitted (back) to at least one vehicle.

According to one advantageous configuration, it is proposed that the at least one GNSS parameter describes a propagation path between the GNSS satellite and the GNSS receiver (e.g. pseudorange). According to another advantageous configuration, it is proposed that the at least one measurement dataset comprises the position, of the GNSS receiver, at which the GNSS signal was received. This can be a vehicle position, for example, if the GNSS receiver is arranged in or on a vehicle.

According to another advantageous configuration, it is proposed that segmented linear regression is applied to at least part of the measurement dataset in step b). In other words, this can also be described by stating that segmented linear regression can be used for modeling as a preference and by way of illustration.

According to another advantageous configuration, it is proposed that the model parameter is a statistical parameter and, or a dependency parameter. The statistical parameter can be a mean value and/or a variance, for example. The dependency parameter can be for example the variation of the value (or GNSS profile) to be modeled e.g. as the height of the GNSS reception antenna varies.

According to another advantageous configuration, it is proposed that a model parameter is determined using multiple measurement datasets. In this regard, for example multiple measurement datasets that can be assigned to the same (geodetic) position or to an area around this position can be used to determine the model parameter.

According to another advantageous configuration, it is proposed that the model is provided in the form of a correction model. In this regard, the model can for example output an ascertained correction value (output variable) on the basis of a (geodetic) position (input variable) e.g. of a vehicle.

The model described here can comprise not only the (geodetic) position but also a whole range of other possible parameters as input variables and output variables.

By way of example, at least one of the following parameters can be an output variable of the model:
pseudorange (propagation delay of the satellite signals from the satellite to the sensor), and
PR error (error in the pseudorange).

At least one of the following parameters can be an input variable of the model:
signal strength of the GNSS signals received from the GNSS sensor,
noise ratio (C/N0=carrier-to-noise density ratio) of the GNSS signals received from the GNSS sensor,
carrier phase of the GNSS signals received from the GNSS sensor,
antenna height of the antenna of the GNSS sensor,
temporal dynamics of the movement of the respective GNSS satellites.

The model uses the model parameters to model the distribution of a GNSS parameter in compact form. The model preferably comprises parameter limit values. The output variables preferably each. comprise static partial variables that reflect the uncertainty when using the model. Particularly preferably, each output variable comprises an expectation value that provides the actual output variable and a variance describing an uncertainty of the respective expectation value.

According to another advantageous configuration, it is proposed that the model is provided in such a way that it can be used for pattern-recognition-based location. In other words, this can also be described by stating that the model is designed to represent for one or more GNSS fingerprints.

According to another aspect, a computer program for carrying out a method that is described here is also proposed. In other words, this concerns in particular a computer program (product), comprising instructions that, when the program is executed by a computer, cause said computer to perform a method that is described here.

According to another aspect, a machine-readable storage medium on which the computer program is stored is also proposed. The machine-readable storage medium is normally a computer-readable data medium.

There is additionally intended to be a description here of a position sensor designed to carry out a method that is described here. By way of example, the storage medium described above can be part of the position sensor or may be connected thereto. The position sensor is preferably arranged in or on a (motor) vehicle or intended or designed for installation in or on such a vehicle. The position sensor is preferably a GNSS sensor. The position sensor is moreover preferably intended and designed for autonomous operation of the vehicle. Moreover, the position sensor can be a combined motion and position sensor. Such a sensor is particularly advantageous for autonomous vehicles. By way of example, the position sensor, or a computing unit (processor) of the position sensor, can access the computer program described here in order to perform a method that is described here.

The details, features and advantageous configurations discussed in regard to the method can accordingly also arise for the position sensor, the computer program and/or the storage medium presented here, and vice versa. In this respect, reference is made to the entire content of the embodiments there for the purpose of characterizing the features in more detail.

The solution presented here and the technical environment for said solution are explained more thoroughly below with reference to the figures. It should be pointed out that the invention is not intended to be restricted by the exemplary embodiments shown. In particular, unless explicitly shown otherwise, it is also possible to extract partial aspects of the substantive matter explained in the figures and to combine said partial aspects with other parts and/or insights from other figures and/or the present description. In the figures:

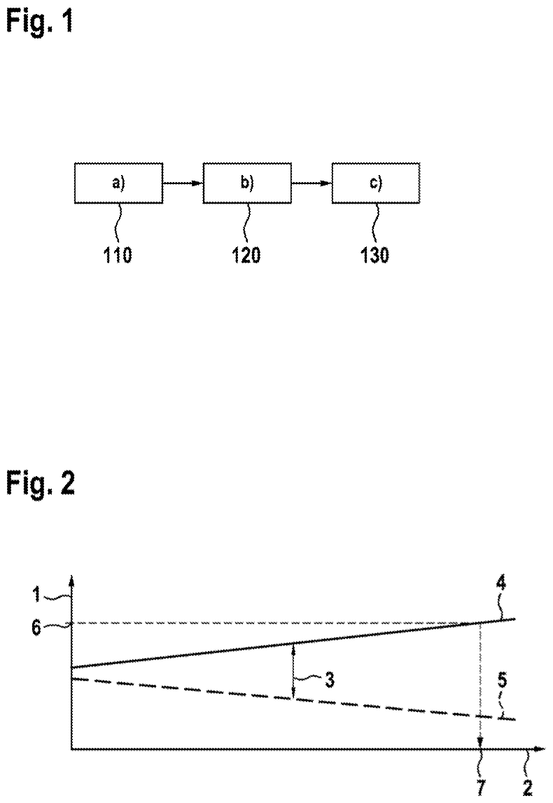

FIG. 1: schematically shows a flowchart for the described method,

FIG. 2: schematically shows an example of a model for describing a GNSS profile, and

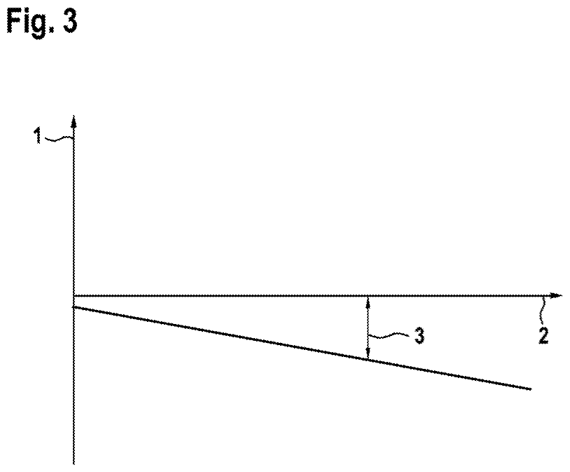

FIG. 3: schematically shows an example of an error profile for pseudoranges.

FIG. 1 schematically shows a flowchart for the described method. The method is used to determine a model for describing at least one environment-specific GNSS profile. The order of steps a), b) and c) that is depicted by the blocks 110, 120 and 130 is illustrative and can arise as such for a normal operating cycle.

In block 110, step a) involves receiving at least one measurement dataset that describes at least one GNSS parameter of a GNSS signal between a GNSS satellite and a GNSS receiver. In block 120, step b) involves determining at least one model parameter for a model for describing the at least one environment-specific GNSS profile, using the measurement dataset received in step a). In block 130, step c) involves providing the model for describing the at least one environment-specific GNSS profile.

FIG. 2 schematically shows an example of a model for describing a GNSS profile. In this case, the pseudorange 1 (symbol: PR) is plotted over the position 2, for example a vehicle position (symbol: x). The profile comprises a non-line-of-sight pseudorange 4 and a line-of-sight pseudorange 5. In addition, FIG. 2 shows by way of illustration that the difference between these two pseudoranges 4, 5 can be described as an error value 3 (symbol ε).

FIG. 2 therefore shows a simplified example of a GNSS profile, in this example for representing the mean value of the pseudorange (PR) of a specific satellite (SV) on the basis of the (vehicle) position. Accordingly, the GNSS profile and the model parameter may have been created for other GNSS signal characteristics (such as e.g. received GNSS signal power, Doppler, etc.) and for other dimensions (physical dimension and direction of the SV in question). Furthermore, an applicable GNSS profile and an applicable model parameter may be available, or can be determined, for each satellite received.

In regard to the method described here, the error value 3 from FIG. 2 can be used as a model parameter for a model for describing the at least one environment-specific GNSS profile, for example. This model parameter can (as shown) be derived, by way of illustration, by obtaining the difference between the curve of the non-line-of-sight pseudorange 4 and the curve of the line-of-sight pseudorange 5. This is also an example of the fact that, and if applicable how, the at least one GNSS parameter 4, 5 can describe a propagation path between the GNSS satellite and the GNSS receiver. Since the model parameter describes a mean value of the pseudorange (PR) of a specific satellite (SV) on the basis of the (vehicle) position, this is also an example of the fact that, and if applicable how, the model parameter can be statistical parameter.

In addition, the at least one measurement dataset can comprise the position, of the GNSS receiver, at which the GNSS signal was received. Furthermore, for example segmented linear regression can be applied to at least part of the measurement dataset in step b). Further, model parameter can be determined using multiple measurement datasets.

FIG. 3 schematically shows an example of an error profile for pseudoranges.

In this case, FIG. 3 illustrates an approach to generating innovative correction data by way of illustration. This is of particular interest for correcting pseudorange and carrier phase in the GNSS receiver.

The correction value is ascertained by considering both setpoint value and actual value in the GNSS measurement datasets. To this end, the actual value is taken directly from the GNSS measurements (propagation delay measurement for the GNSS signal); the setpoint value is ascertained indirectly from the known receiver position and the satellite position (can be calculated offline).

In a variant, profiles are created both for the setpoint values and for the actual values. In this regard, it is preferred if the at least one model parameter itself is formed in the manner of an (environment-specific) profile.

FIG. 2 shows an applicable example of the pseudorange. As such, the NLOS_PR values 4 represent the actual values (actual profile) and the LOS_PR values 5 represent the setpoint values (setpoint profile). By obtaining the difference for the values comprising setpoint values and actual values (e.g. error value ε=setpoint value minus actual value), the associated error values 3 are ascertained, which can be represented as an error profile.

FIG. 3 shows the error profile for the pseudoranges that is derived from the GNSS profiles in FIG. 2. The curve shown in FIG. 3 could be used as a model parameter that has itself been formed in the manner of an (environment-specific) profile. In other words, this can in particular be described as a specific sequence of model parameters or as a model characteristic curve, which are able to be determined in step b).

The error value 3 here is an example of the model parameter. The error value 3 can be used to correct future GNSS measurements. FIG. 3 is therefore also an example of the fact that, and if applicable how, the model can be provided in the form of a correction model.

If just the approach for generating correction data is to be pursued, correction data can also be generated from the GNSS measurement datasets directly, which means that the profiles for the GNSS signal traits (measured pseudorange, signal power, Doppler, carrier phase) are not generated first, but rather the correction values are generated as profiles (or error profiles) directly instead. In other words, this means in particular that the at least one model parameter is determined directly from the GNSS measurement datasets in this case (without diversion via actual and setpoint profiles).

The correction data determined in this manner can correct the error influences as a result of the GNSS signal interacting with surrounding objects (e.g. reflection from buildings), and therefore advantageously provide innovative correction data. These correction data can be provided to a vehicle in the following illustrative ways:
Innovative correction data are integrated into existing correction data services (e.g. OSR, SSR). That is to say that the vehicle notifies the correction data service provider (KDP) of its position and the KDP transmits the current corrections to the vehicle, e.g. by the second.
The vehicle notifies the KDP of its probable trajectory and the KDP provides the correction data in the form of error profiles (if applicable in parameterized form) for the route ahead.
The vehicle has a map layer containing correction data, the content of which is provided by the KDP and can be preloaded and optionally persisted for an extensive area (e.g. one or more tiles) in the vehicle. This map layer can be updated e.g. at specific intervals (e.g. weekly) or when new data are available with the KDP.

The GNSS measurement data can be corrected in the vehicle by applying the associated correction value to the current actual value, e.g. by obtaining the sum of the current GNSS measured value determined in the vehicle (e.g. the currently measured PR of a specific SV) and the associated correction value (i.e. the correction value valid for the current vehicle position and SV) (here the PR error).

Alternatively or additionally, the model can be provided in such a way that it can be used for pattern-recognition-based location.

An approach to using the model for describing the GNSS profiles that is advantageous in this regard is to use the model, or at least a portion thereof, as a reference for pattern-recognition-based location. Depending on the satellite constellation and impairment of the GNSS signals by the specific environment, there is a resultant specific impairment of the GNSS signal traits, here in the form of specific GNSS profiles. Since a GNSS profile represents a value of the GNSS signal trait (e.g. pseudorange, Doppler, signal power, etc.) on the basis of a location and the direction of the associated satellite, knowledge of the current satellite position allows the position of the vehicle to be inferred by comparing the GNSS measured values currently measured in the vehicle (e.g. pseudorange, Doppler, signal power, etc.) with the GNSS profiles (here using the (simplified) model for describing the GNSS profiles).

FIG. 2 illustrates this circumstance through simplified use of the GNSS profile of just one SV, the GNSS signal of which is received from a specific direction. In this example, a specific value 6 is measured for the pseudorange at the current time (“measured PR”). Comparison of this measured value 6 with the ACTUAL values from the GNSS profile for the pseudorange 4 (“NLOS_PR”) allows the position 7 for which the measured value can be expected (“x′ estimated position”) to be inferred.

Various criteria are possible for ascertaining the similarity between current GNSS measured value (M) and the values of the GNSS profile (R(x): reference value at position x): examples are (shown by way of example for the example in FIG. 2):
Simple deviation (abs(M−R(x))); in this case the smallest deviation is sought;
Squared deviation ((M−R(x))\hat{ }2); in this case the smallest squared deviation is sought;
The probability of the value (P(M,x): probability of the value M being measured at position x); in this case the greatest probability is sought.

The reliability of this method can be significantly improved in particular by using the GNSS profile not just for one SV but rather for multiple SVs, e.g. the GNSS profiles of all of the SVs currently received (i.e. all of the satellites currently received). in addition, the reliability of the method can be improved further if not only the GNSS profiles of one GNSS signal trait (e.g. pseudorange) but additionally the GNSS profiles for other GNSS signal traits (e.g. signal power) are used.

If, by way of example, the simple deviation is to be used as a comparison criterion, the estimated position x′ of the receiver is obtained by virtue of the sum of the deviation between the currently measured GNSS values and the values of the GNSS profiles associated with a position x, in consideration of various positions x, reaching a minimum at x′ over all of the GNSS profiles used

$${x}^{′} = {min}_{x} {\sum }_{SV , GNSS - signal trait} \vert {W}_{SV , GNSS - signal trait} - {R}_{SV , GNSS - signal trait} ( x ) \vert$$

In this example, W_{SV,GNSS signal trait} is the measured value of a GNSS signal trait associated. with the satellite SV; R_{SV,GNSS signal trait}(x) is the reference value of the GNSS profile associated with the applicable GNSS signal trait of the satellite SV if position x is assumed. Position x can be expanded to a multidimensional space (e.g. 2D or 3D) without restricting the generality.

The model for describing the GNSS profiles that is to be used for the GNSS fingerprint method shown here can be made available in the vehicle as an additional data layer of a roadmap (e.g. NDS). In an advantageous variant, applicable data layers are provided by a service provider, e.g. by means of IP communication by mobile radio and/or WLAN. As transmission strategy, the vehicle can e.g.:
request GNSS profiles and applicable model parameters for the route ahead on the basis of MPP;
preload the GNSS profiles and applicable model parameters for a larger area, e.g. one or more tiles.

The model for describing the GNSS profiles can be persisted in the vehicle until the service provider has updated GNSS profiles, or an updated model, available.

Another advantageous approach to using the model for describing the GNSS profiles that is advantageous in this regard (pattern-recognition-based location) is to combine the two aforementioned approaches (correction data+pattern-recognition-based location).

As such, in one variant, the pseudoranges can be corrected first, as a result of which the GNSS receiver uses them to calculate a more accurate initial position. In a further step, a comparison using the GNSS fingerprint method can be carried out. A more favorable initial position is therefore obtained for the GNSS fingerprint method, allowing a better response to possible ambiguities.

1. A method for determining a model that describes at least one environment-specific GNSS profile, the method comprising:
receiving at least one measurement dataset that describes at least one GNSS parameter of a GNSS signal between a GNSS satellite and a GNSS receiver;
determining, using the at least one measurement dataset, at least one model parameter of the model that describes the at least one environment-specific GNSS profile; and
providing the model that describes the at least one environment-specific GNSS profile.

2. The method as claimed in claim 1, wherein the at least one GNSS parameter describes a propagation path between the GNSS satellite and the GNSS receiver.

3. The method as claimed in claim 1, wherein the at least one measurement dataset includes a position of the GNSS receiver at which the GNSS signal was received.

4. The method as claimed in claim 1, the determining the at least one model parameter further comprising:
applying a segmented linear regression to at least part of the at least one measurement dataset.

5. The method as claimed in claim 1, wherein the at least one model parameter is a statistical parameter.

6. The method as claimed in claim 1, wherein the at least one measurement dataset includes multiple measurement datasets, the determining the at least one model parameter further comprising:
determining the at least one model parameter using the multiple measurement datasets.

7. The method as claimed in claim 1, the providing the model further comprising:
providing the model in a form of a correction model.

8. The method as claimed in claim 1, the providing the model further comprising:
providing the model in such a way that the model can be used for pattern-recognition-based location.

9. The method as claimed in claim 1, wherein the method is carried out by a computer program.

10. A machine-readable storage medium that stores a computer program for determining a model that describes at least one environment-specific GNSS profile, the computer program having instructions that, when executed on a computer, cause the computer to:
receive at least one measurement dataset that describes at least one GNSS parameter of a GNSS signal between a GNSS satellite and a GNSS receiver;
determine, using the at least one measurement dataset, at least one model parameter of the model that describes the at least one environment-specific GNSS profile; and
provide the model that describes the at least one environment-specific GNSS profile.
